(19) United States
(12) Patent Application Publication
(10) Pub. No.: US 2019/0027061 A1
(43) Pub. Date: Jan. 24, 2019

(54) SYSTEM, LEARNING MATERIAL, AND COMPUTER READABLE MEDIUM FOR EXECUTING HANGUL ACQUISITION METHOD BASED ON PHONETICS

(71) Applicant: Taemin Kim, Santa Clara, CA (US)

(72) Inventor: Taemin Kim, Santa Clara, CA (US)

(21) Appl. No.: 16/138,506

(22) Filed: Sep. 21, 2018

Related U.S. Application Data
(63) Continuation-in-part of application No. PCT/US2016/023597, filed on Mar. 22, 2016.

(51) Int. Cl. G09B 19/06; G10L 15/187

(52) U.S. Cl. CPC G09B 19/06; G10L 15/187

(57) ABSTRACT

A Hangul acquisition method and system based on its phonetic and design principles enable a learner to effectively and efficiently master Hangul. Based on a scientific paradigm, the Hangul acquisition method of the present disclosure formulates nested trilateral structures in Hangul. It helps the learner outline the underlying principles of Hangul succinctly and master the letter-sound mapping incrementally. In addition, the present disclosure provides a learning material or a non-transitory computer-readable medium to execute the Hangul acquisition method.

### FIELD OF THE INVENTION

The present disclosure relates to the field of Hangul acquisition, and specifically to a method and system to master letter-sound mapping of Hangul based on its phonetic and design principles.

### BACKGROUND OF THE INVENTION

While we learn a writing system in general use by rote for a long time, the greater knowledge of Hangul helps learners the better read Korean words (Choi N Y, Yi S H, The effects of alphabet knowledge on Korean kindergarteners' reading of Hangul words. Journal of Korean Home Management Association, 2007; 25(3): 151-168). The Korea Patent Application (KPA) No. 10-2012-0114042 populates vowel letters by combination of ⋅, -, and |. Another KPA No. 10-2015-0046823 presentes consonant letters by their established principles. The other KPA No. 10-2012-0139225 applies four basic arithmetic operations to come up with Hangul letters. However, they contrive arbitrary or imperfect rules of the Hangul letters without phonetic comprehension.

The underlying principles of Hangul should be succinctly and completely tied in a scientific framework because clumsy rules would rather confuse than ease the learner. It is also important for the learner to compose and practise syllables first with simple sounds and letters.

### BRIEF SUMMARY OF THE INVENTION

A Hangul acquisition method and system based on its phonetic and design principles enable a learner to effectively and efficiently master Hangul. Based on a scientific paradigm, the Hangul acquisition method of the present disclosure formulates nested trilateral structures in Hangul. It helps the learner outline the underlying principles of Hangul succinctly and master the letter-sound mapping incrementally. In addition, the present disclosure provides a learning material or a non-transitory computer-readible medium to execute the Hangul acquisition method.

The invention will enable the learner to intuitively understand and practise the underlying principles of Hangul by himself without rote learning. Their phonetic and graphic symmetries bring synergistic effects and greater efficiency in Hangul acquisition. Remakably, both vowel and consonant letters are tabulated by their articulatory features and formation processes. The invention will, therefore, enhance four language skills of the Korean language. Furthermore, the articulatory features of Hangul letters enable us to define a bit-position encoded character set that simplifies encoding and decoding their bitstreams. For the argument, the present disclosure makes do with the International Phonetic Alphabet (IPA) for phonetic transcriptions of Hangul.

Some linguistic terms are introduced to specify the present disclosure:
(a) phoneme: the smallest phonetic unit that distinguishes meaning in a spoken language;
(b) grapheme: the smallest graphic unit that distinguishes meaning in a written language;
(c) graphoneme: grapheme and/or phoneme, or their correspondence;
(d) speech syllable: the smallest phonetic unit of a word in a spoken language; and
(e) graphic syllable: the smallest graphic unit of a word in a written language.

Other terms are defined herein as having their broadest meanings to an ordinary skill in the art. (1) The terms “non-transitory computer-readable medium” or “tangible memory” refer to any storage device that can store data which a computer system can read thereafter. They include read-only memory, random-access memory, CD-ROM, magnetic tape, floppy disk, optical data storage device, etc. They can be distributed over network-coupled computer systems wherein the computer readable code is stored and executed in a distributed fashion. (2) The term “module” or “session” refers to software, a circuit, hardware, or a combination thereof designed to perform an associated function, where the software includes executable instructions in a tangible memory. (3) The term “learning material” refers to any type of materials and resources in relation to teaching or learning situations. It includes text, object, chart, picture, book, film, gesture, etc.

In the present disclosure, the scientific paradigm, named Hundlism, summarizes articulatory phonetics and design principles of Hangul with which all embodiments may present syllables or graphonemes. The Hundlism conceives a trilateral process and reality in nature such that one represents a diverging process or derived thing; another represents a converging process or basic thing; and the other represents a binding process or composed thing. The speech syllable has a trilateral structure in time such that an initial phoneme, if any, is an opening sound of a syllabic segment; a medial phoneme is a lasting sound of the syllabic segment; and a final phoneme, if any, is a closing sound of the syllabic segment. The graphic syllable has a trilateral structure on paper such that an initial grapheme, if any, is placed at the top of a syllable block; a medial grapheme is placed in the middle of the syllable block; and a final grapheme, if any, is placed at the bottom of the syllable block. Phonemes and graphemes for the syllables can be organized by their trilateral, quadrilateral, or mixed formation processes.

Hangul Acquisition System

According to the present disclosure, all Hangul acquisition systems include a Hundlism session presenting the Hundlism. They may include a syllable session presenting at least one syllable; an interaction module exchanging audiovisual data with a learner; or an evaluation module testing and evaluating at least one of four language skills for syllables or graphonemes.

According to an embodiment of the present disclosure, a Hangul acquisition system may include a graphoneme session presenting at least one graphoneme. Another Hangul acquisition system may include a vowel session presenting at least one vowel graphoneme; and a consonant session presenting at least one consonant graphoneme. The other Hangul acquisition system may include a primitive graphoneme session presenting at least one primitive graphoneme in which the grapheme outlines an articulator of corresponding phoneme. It may include a secondary graphoneme session presenting at least one secondary graphoneme in which the grapheme outlines an articulation manner of corresponding phoneme. It may include a tertiary graphoneme session presenting at least one of derivative and composite graphonemes in which the grapheme denotes an articulatory feature of corresponding phoneme.

Tangible Memory for Hangul Acquisition

According to an embodiment of the present disclosure, a tangible memory stores a program causing a computer to execute Hangul acquisition method, wherein the method presents the Hundlism; at least one syllable; and at least one graphoneme. Another tangible memory stores a program causing a computer to execute Hangul acquisition method, wherein the method may present the Hundlism; at least one vowel graphoneme; and at least one consonant graphoneme.

Hangul Learning Material

A Hangul learning material according to an embodiment of the present disclosure includes a Hundlism section presenting the Hundlism; a syllable section presenting at least one syllable; and a graphoneme section presenting at least one graphoneme.

### BRIEF DESCRIPTION OF DRAWINGS

The same or similar elements are indicated by like reference numbers in the drawings of which:

FIG. 1 illustrates Hangul Wing including vowel and consonant tables with syllabic wings;

FIG. 2 illustrates an internet application of a Hangul acquisition system;

FIG. 3 illustrates round and rectangular Hundli patterns cubistically depicting the Hundlism;

FIG. 4 illustrates a Hangul acquisition system under an embodiment of the present disclosure;

FIG. 5 illustrates quadrilateral letter and sound modules for Hangul syllables and graphonemes;

FIG. 6-8 illustrate flowcharts of syllable, graphoneme, and language evaluation modules;

FIG. 9 summarizes the trilateral structures of letters and sounds at the highest level;

FIG. 10 illustrates simple vowel and consonant spaces spanned by their articulatory features;

FIG. 11 summarizes vowel and consonant formation rules from their articulators and geometries;

FIG. 12 illustrates the primitive vowels whose letters outline their vibrant articulators;

FIG. 13 illustrates the iotized and composite vowels from the pictographic vowels;

FIG. 14 illustrates the relative movements of active palates for the secondary vowels;

FIG. 15-16 illustrate the pictographic consonants whose letters outline their articulators;

FIG. 17 illustrates lax consonants twice differentiable by the ternary burst strength;

FIG. 18 illustrates the primitive syllables composed of the primitive vowels and consonants; and

FIG. 19 illustrates monosyllabic and disyllabic names of the primitive consonants.

### DETAILED DESCRIPTION OF THE PREFERRED EMBODIMENTS

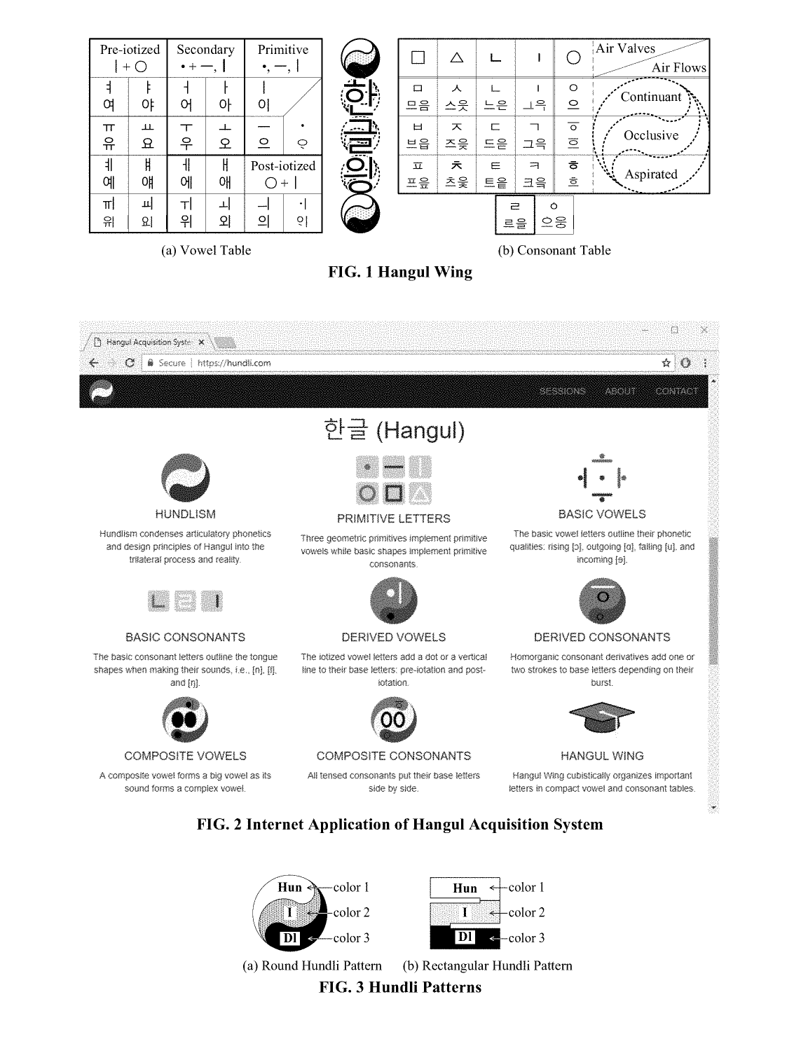

While the detailed description contains many specific techniques and methods, these should not be construed as limitations on the scope of the present disclosure, but as exemplifications of the presently preferred embodiments thereof. Many other ramifications and variations of Hangul acquisition method and system are possible within the present disclosure. For example, a Hangul lesson may simply present the letter-sound mapping according to Hangul Wing in FIG. 1. Another example is an internet application that introduces Hundlism and presents both phonetic articulations and design principles of Hangul letters with their letter formation in FIG. 2.

Hangul Acquisition System

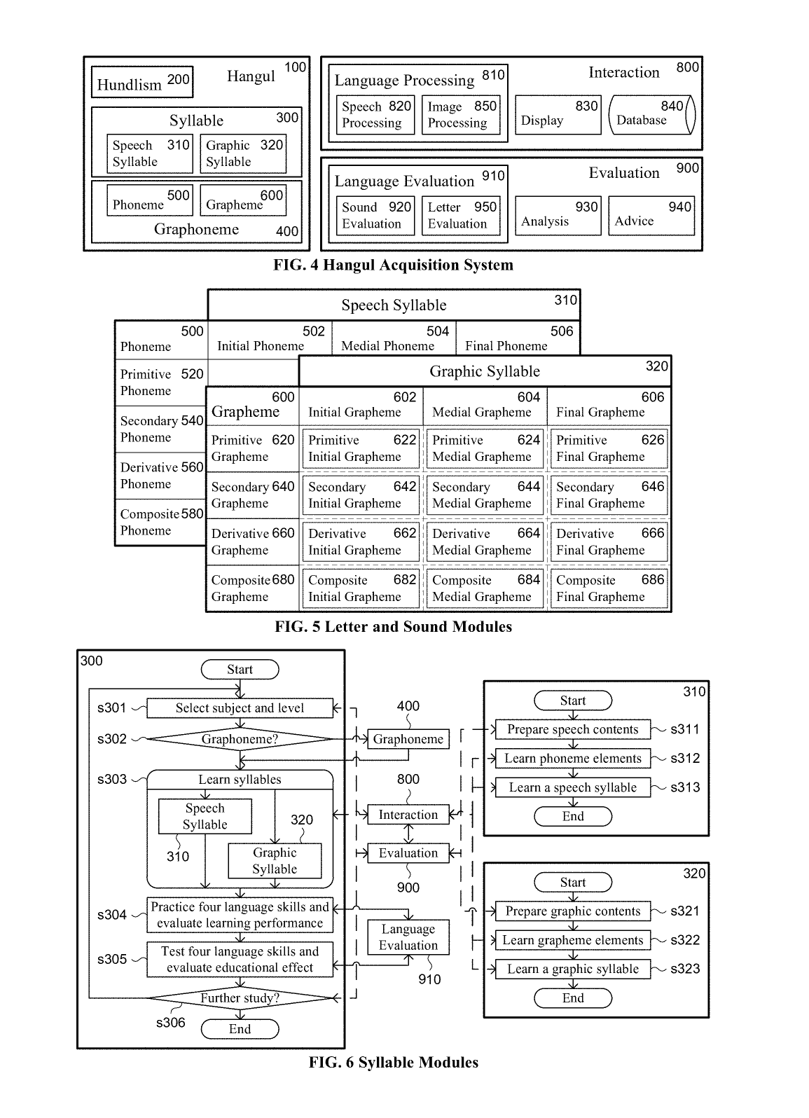

A Hangul acquisition system of the present disclosure can present personalized Hangul lessons with pervasive interaction by operably connecting the Hangul module 100, interaction module 800, and evaluation module 900 in FIG. 4. It may be implemented as a website, an internet application, a mobile application, or a desktop application running on a computing device in which a processor executes the module from a memory and an interface device interacts with a learner. It may practise and test the learner in four language skills of syllables and graphonemes to evaluate his performance and educational effect of the Hangul lessons for better contents and styles. Connected to the internet, it may share and process various data and resources to enhance its performance and reliability. It can use various linguistic and educational materials for Hangul acquisition. It can build a knowledge database of educational experts for further analyses and educational advices. It can utilize distributed computer systems with high-computing power to process and analyze big data in the database.

Hangul Module

The Hangul module 100 of the present disclosure operably connecting the Hundlism module 200, syllable module 300, and graphoneme module 400 can present a learner with personalized Hangul lessons from fundamental principles to the letter-sound mapping. It may change content, styles, and levels of Hangul lessons to accommodate his preference and learning curve. Based on his performance, it can foster an educational environment to promote active learning and maximize the educational effect of the Hangul lessons on him. The Hundlism module 200 can present the Hundlism and exemplify a speech production process and writing system with other processes and realities in the world. The syllable module 300 and graphoneme module 400 presenting syllables and graphonemes, respectively, may share submodules assorted by their bilateral, trilateral, or quadrilateral structures. The submodules in the Hangul module 100 can present concise, self-contained lessons with step-by-step instructions and suggest backward or forward steps to consider his learning curve and maximize their educational effect on him.

By the trilateral structure of a syllable, the syllable module 300 may classify all graphonemes into initial, medial, final ones. By the trilateral graphoneme formation process, the phoneme module 500 may classify all phonemes into basic, derivative and composite phonemes while the grapheme module 600 may classify all graphemes into pictographic, derivative, and composite graphemes. They may subdivide their first categories into primitive and secondary ones for quadrilateral formation processes and thus populate their twelve modules in FIG. 5. For example, a pictographic medial grapheme module may include the primitive medial grapheme module 624 and secondary medial grapheme module 644. A mixture of trilateral and quadrilateral formation processes defines a mixed formation process for both phoneme and grapheme.

Syllable Module

The syllable module 300 of the present disclosure can present and practise syllables with their trilateral phonetic and graphic principles including initial, medial, and final graphonemes. In FIG. 6, it may operably connect the speech syllable module 310 and graphic syllable module 320 to map speech and graphic syllables in both ways and practise a learner in their four language skills. First, the learner or evaluation module 900 can choose syllables and their levels (s301). If he wants to learn graphonemes in the syllables, the graphoneme module 400 is executed (s302). For selected syllables, the speech syllable module 310 or graphic syllable module 320 are executed selectively or alternately (s303). It can evaluate his performance while he practises four language skills of the syllables (s304). It can also evaluate its educational effect while he tests himself for four language skills of the syllables (s305). Finally, he can repeat it for further study possibly with educational advices from the evaluation module 900 (s306).

The speech syllable module 310 of the present disclosure can present speech syllables with their trilateral articulatory phonetics as on the right top of FIG. 6. First, it prepares educational contents for a speech syllable and level (s311). It presents the initial, medial, and final sounds of the speech syllable (s312). It presents the speech syllable seamlessly blending the initial, medial, and final sounds (s313). On the right bottom of FIG. 6, the graphic syllable module 320 of the present disclosure does likewise to present graphic syllables with their trilateral design principles.

Graphoneme Module

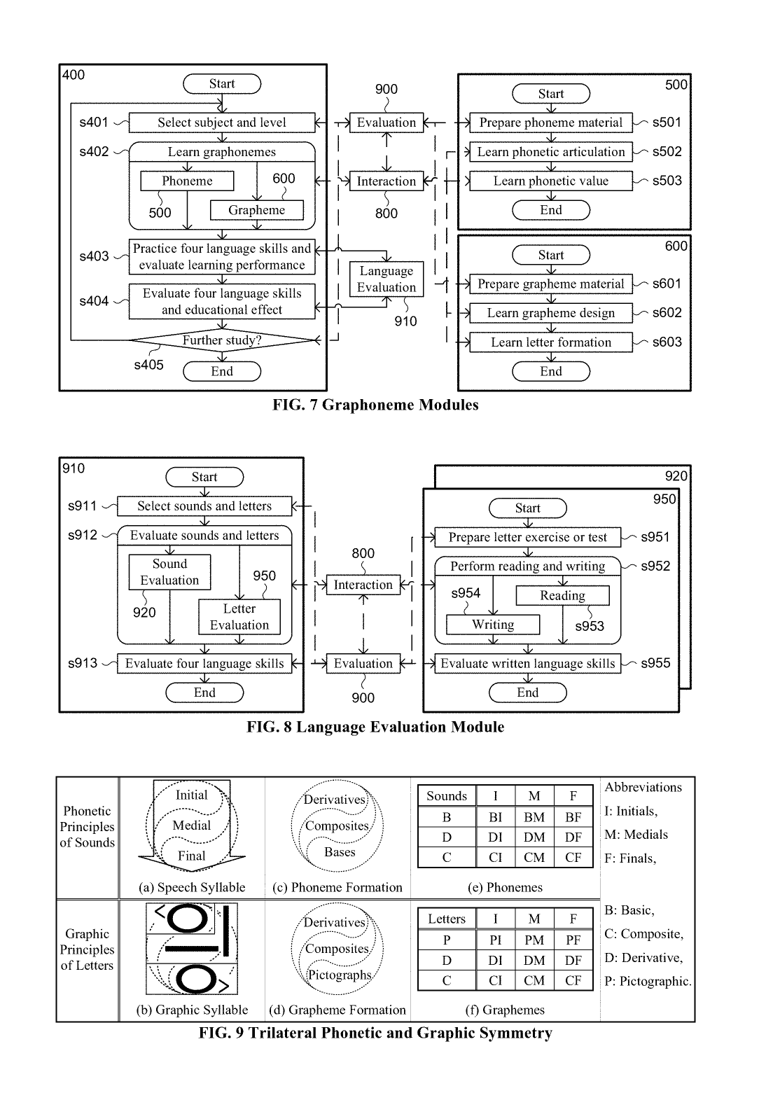

The graphoneme module 400 of the present disclosure can present and practise graphonemes with their phonetic and design principles in the articulatory profiles or 3D rendering. In FIG. 7, it can present graphonemes both ways and evaluate a learner in their four language skills. First, the learner or evaluation module 900 can choose graphonemes and their levels (s401). For the graphonemes, the phoneme module 500 or grapheme module 600 are executed selectively or alternately (s402). It may evaluate his performance while he practises their four language skills (s403). It may evaluate its educational effect while he tests himself for their four language skills (s404). Finally, he can repeat it for further study with educational advices (s405).

The phoneme module 500 of the present disclosure may present phonemes with their articulatory phonetics as on the right top of FIG. 7. First, it prepares educational contents for a phoneme and level (s501). The phonetic articulation of the phoneme (s502) is presented with the phonetic value (s503). On the right bottom of FIG. 7, the grapheme module 600 of the present disclosure does likewise to present graphemes with their design principles and letter formations.

Evaluation Module

The evaluation module 900 of the present disclosure operably connecting the language evaluation module 910, analysis module 930, and advice module 940 can evaluate a learner and Hangul lessons from basic to further analyses. With available interaction devices, it can configure evaluation methods, level the further analyses, estimate their educational effect, and provide him educational advices accordingly. It can set questions for a test of four language skills and evaluate his answers in multilateral aspects for various errors and their probabilities. Beyond the basic analysis, the analysis module 930 can perform sophisticated analyses for his learning curve and educational effect of Hangul lessons with integrated database of individuals or other users. Beyond analytical evaluation, the advice module 940 can provide customized advices to him based on educational directives from educational experts with long experience.

The language evaluation module 910 of the present disclosure operably connecting the sound evaluation module 920 and letter evaluation module 950 can test and evaluate four language skills for graphonemes and syllables as in FIG. 8. First, a learner or the evaluation module 900 can choose sounds, letters, and their levels (s911). For selected sounds and letters, the sound evaluation module 920 or letter evaluation module 950 are executed selectively or alternately (s912). Lastly, it evaluates his overall four language skills (s913).

The letter evaluation module 950 of the present disclosure can evaluate the written language skills for graphemes and graphic syllables as on the right of FIG. 8. First, it prepares letters and their levels for exercises (or tests) (s951). For selected letters, it performs reading (s953) or writing (s954) exercises (or tests) selectively or alternately (s952). Lastly, it evaluates overall written language skills for the letters (s955). The sound evaluation module 920 does likewise to evaluate the listening and speaking skills of the spoken language. Both modules can compute quantitative distances and confidence values of answers for further analyses.

Interaction Module

The interaction module 800 of the present disclosure operably connecting the language processing module 810, display module 830, and database module 840 can process and exchange various data between a learner and the Hangul acquisition system with all resources available to foster a user-friendly interaction. It can process and output audiovisual data and information from the Hangul acquisition system upon his preference and educational directive. Conversely, it can collect and process his responses to support interactive Hangul lessons. The display module 830 can manipulate, configure, and display all visual information. The database module 840 can store all educational data and information as well as interaction history of the system.

The language processing module 810 including the speech processing module 820 and image processing module 850 can generate and process all input and output data in the Hangul acquisition system. It can collect audiovisual data from a learner to diversify his input methods and evaluate his performance via speech and image recognition. In doing so, it can handle the probabilistic ambiguity of the speech and image recognition and measure multilateral aspects of various possibilities. The image processing module 850 can compress and restore a large amount of image and video data in real time to save storage space in the database.

Hangul Acquisition Method

As the best mode of Hangul acquisition according to the present disclosure, vowels and consonants are alternately presented by order of their formation processes based on the Hundlism which embraces basic phonetics of the sound and design of the writing system: (a) primitive vowels, (b) primitive consonants (initials and finals), (c) secondary vowels, (d) secondary consonants, (e) iotized vowels, (f) derivative consonants, (g) composite vowels, and (h) tensed consonants. Once primitive finals are presented in detail, the rest finals can follow their initials simply with their reverse articulations and phonetic values. Pre-iotized vowels of the secondary vowels can be presented earlier than their post-iotized vowels for educational purpose.

Hundli Theory

The Hundli theory, or Hundlism, of the present disclosure scientifically condenses articulatory phonetics and design principles of Hangul into the trilateral process and reality of the nature. The Hundlism conceives and embraces dual aspects of the nature, i.e., being and becoming, and encompass their trilateral structures, i.e., basic, derived, and composite things as well as creation, development, and destruction processes. The Hun⋅dl⋅i, a trisyllable compound word of ⋅ (Hun [hΛn]), [symbol] (Dl [d [symbol] ]), and ∘| (I [i]) in Korean, is coined to depict the universal dynamics of the world as a whole. First, ⋅ in Korean is the root of a few derivative words meaning great, sky, or one. Among those, the sky is a symbol of the diverging process or derived thing. Second, [symbol] means the flat ground, a symbol of the converging process or basic thing. Third, ∘| means a person or thing, a symbol of the living thing in harmony, which represents the binding or balance of Hun and Dl. The Hundlism characterizes holistic, bilateral, and trilateral aspects of the world in that the one substance conceives and embraces its two opposite properties.

Hundli patterns of the present disclosure can visualize the key concepts of the Hundlism and enhance the comprehension. They cubistically depict the harmonic dynamics of two opposites from one substance as a process or reality in FIG. 3. A round Hundli pattern in FIG. 3a splits the boundary between two properties in the color 1 and 3 enough to show the original substance in the background of the color 2. The rising part toward right top, falling part toward left bottom, and binding part inbetween represent Hun, Dl, and I, respectively. The Hundli pattern visualizes tangible dualities of the world and their bindings in harmony. The Hun and Dl parts of the round Hundli pattern define their directional conventions on paper. Among many ramifications of the Hundli pattern in shapes and colors, FIG. 3b illustrates a rectangular one and three colors can be chosen to manifest their symbols, e.g., red, blue, and yellow. The simplest geometric symbols outlining the distinctive features of Hun, Dl, and I on paper include geometric primitives (a dot, horizontal line, and vertical line) and basic shapes (a circle, square, and triangle), respectively.

In its dual sense of process and reality, the Hundlism of the present disclosure can give a fresh insight into the bilateral or trilateral symmetries between articulatory phonetics and design principles of Hangul in FIG. 9. First, the trilateral structure of a graphic syllable on paper reflects that of a speech syllable in time based on the processing aspect of the Hundlism in FIGS. 9a and b. Second, the substantial aspect of the Hundlism manifests the trilateral symmetries in graphoneme formation processes in FIGS. 9c and d. Third, all combinations of the first two trilateral principles populate nine sets of graphonemes in FIGS. 9e and f, which may compose the phoneme module 500 and grapheme module 600 by their trilateral formation processes.

Trilateral Syllables

The Hundlism of the present disclosure models the trilateral structure of a speech syllable in which the sound forms, lasts, and diminishes in time. In particular, the Hundli pattern outlines the trilateral structure of a speech syllable or segment with opening, lasting, and closing sounds on the falling time axis in FIG. 9a. The speech sound is like the sound of tap water; the airflow switched by an articulator in the vocal tract produces the speech sound as the running water controlled by a faucet on the water pipe produces the tap water sound. Three types of tap water sounds include (a) opening sound when the faucet turns on, (b) lasting sound when the tap water is running, and (c) closing sound when the faucet turns off. By the same token, an articulator in the vocal tract can produce opening, lasting, or closing sounds by its own nature. In some context, opening, lasting, and closing sounds are referred as initial, medial, and final ones, respectively.

The Hundli theory and pattern can transform back and forth the trilateral structures between a speech syllable in time and a graphic syllable on paper as in FIGS. 9a and b. The graphic syllable in FIG. 9b places the initial (^{<}◯), medial ( [symbol] ), and final (◯_{>}) graphemes vertically to the top, middle, and bottom of a syllable block, respectively. Here ◯ and [symbol] denote an arbitrary consonant and vowel, respectively. The angle brackets, i.e., < and >, corresponding to Hun and Dl, respectively, distinguish the opening and closing sounds by a pre-superscript and subscript of ◯. This template of a graphic syllable is named [ [symbol] ] in IPA or simply wing by the phonetic similarity as we read it in Hangul excluding the pre-superscript and subscript. Note that fat, tall, and big vowels having -, |, and both, respectively, are placed to the bottom, right, and both of ^{<}◯. The initial and medial graphemes are essential in a graphic syllable while only medial phoneme is essential in a speech syllable. In a graphic syllable, ∘ is placed in ^{<}◯ if its opening sound is silent while ◯_{>} is omitted if its closing sound is silent.

Trilateral Graphonemes

The Hundli theory and pattern can embraces nested bilateral and trilateral structures in Hangul formation process to enhance their learning effect in Hangul lessons for their repetitive uses in assorted graphonemes. For both vowels and consonants, the grapheme formation process from pictographs through derivatives to composites in FIG. 9d takes after the phoneme formation process from bases through derivatives to composites in FIG. 9c. Here are a few variations: (a) pre-iotized vowels mapped to derivative letters are composite vowels in harmony and (b) tensed sounds mapped to homogeneous digraphs are derivative sounds. As a rule, articulatory and graphic complexities of a graphoneme and syllable alike are proportional to each other.

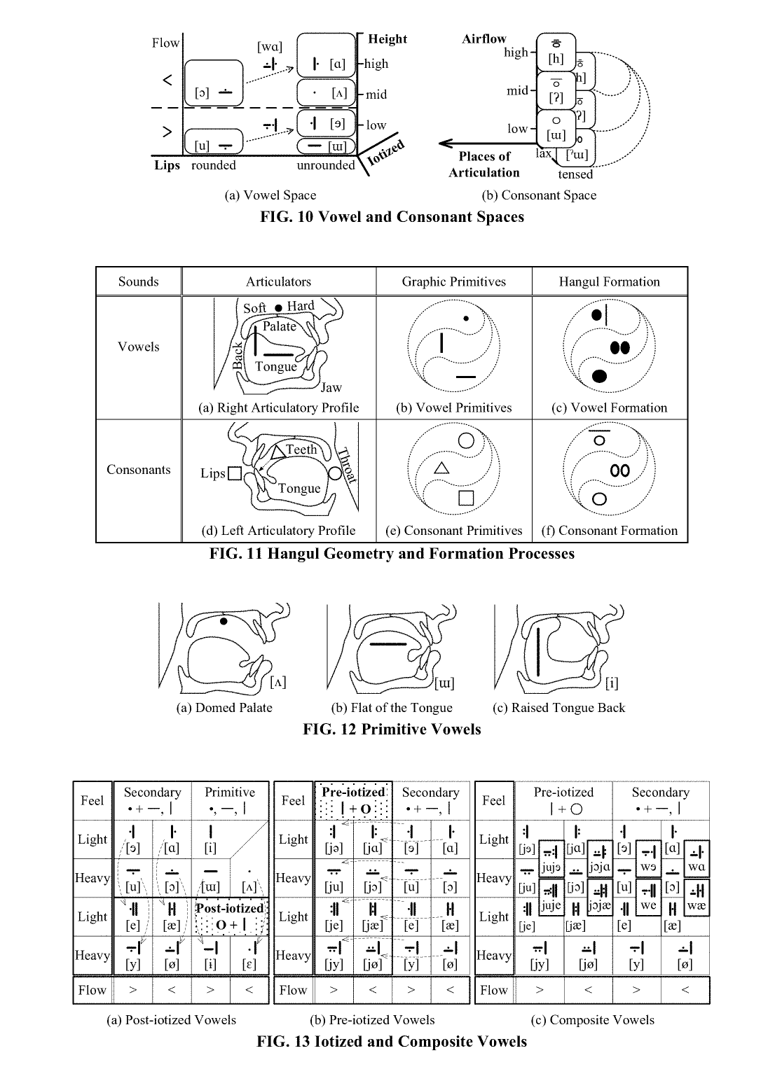

In the phoneme formation process, articulatory features of the present disclosure enable us to effectively reconstruct the phoneme space with phonetic articulations and values. A composite phoneme is obviously defined by composing more than one simple phoneme, which the present disclosure assorts into basic and derivative phonemes. The simple phoneme spaces of Korean vowel and consonant are constructed by their articulatory features in FIG. 10. First, the vowel height, shape of the lips, and height of the tongue back span the simple vowel space whose façade in FIG. 10a is the subspace with the first two. Second, places and manners of articulation, ternary burst strength, and binary tensity span the simple consonant space whose side in an oblique view of FIG. 10b is the subspace with the last two. However, a lay person hardly reproduces the complete vowel space based on distinctive features as linguists do. Alternatively, the articulatory features of the present disclosure include vibrant articulators, palatal movements, and the raised tongue back that effectively reconstruct the vowel space with only a few losses.

The learning milestones of vowel and consonant graphemes from articulators through primitive graphemes to the Hangul formation process are succinctly summarized in FIG. 11. The intuitive symmetries and orderly changes in Hangul primitives and formation processes enhance the comprehension of the underlying principles. The vowel and consonant primitives placed over the Hundli pattern in FIGS. 11b and e take after their articulators in the right and left articulatory profiles in FIGS. 11a and d, and lay the cornerstone of their formation processes in FIGS. 11c and f, respectively. By a cosmic analogy of the mouth in the right articulatory profile, Hun, Dl, and I correspond to the domed palate, flat of the tongue, and raised tongue back as articulatory features of the primitive vowels, respectively. By another cosmic analogy of the oral tract vertically aligned in the left articulatory profile, Hun, Dl, and I correspond to the exhaling throat, air vessel of the lips, and sharp teeth as articulatory features of the primitive consonants, respectively.

The Hangul formation process of the present disclosure formulates pictographic, derivative, and composite graphemes for vowels in FIG. 11c and consonants in FIG. 11f. Here a solid circle (or expanded dot) and hollow one denote arbitrary vowel and consonant graphemes, respectively. Both from Hun in FIGS. 11b and e turn into the pictographic bases on Dl in FIGS. 11c and f to seed the Hangul formation process. First, a vowel pictograph () bears an iotized vowel letter by adding a dot or vertical line (●|) to it and a composite vowel letter combines two graphemes (●●). Note that ●| as a graphic syllable for [i] reminds us the iotized vowel. The dot and vertical line in ●| remind us the letter designs for pre-iotized and post-iotized vowels, respectively. Second, a consonant pictograph (∘) bears a derivative letter (∘̅) by adding a stroke on it and a composite consonant letter combines two graphemes (∘∘). For example, [symbol] denotes the second derivative of ∘ by the burst strength and the homogeneous digraph of a lax sound denotes its tensed sound.

The Hangul acquisition method of the present disclosure proposes to master simpler vowels first because they are complete syllables by themselves and simply compose new syllables with consonants whenever acquired. For a beginner, syllables are easy and stable in terms of phonetic articulation to enhance his learning curves and their education effects on him. A few primitive graphonemes are distinctive and balanced enough for him to practise various speech and graphic syllables with their trilateral correspondences and compositions from early stage. Then, he can master the rest graphonemes efficiently according to the Hangul formation process.

Hangul Wing of the present disclosure in FIG. 1 compactly organizes important letters in vowel and consonant tables according to the Hangul formation process. Like a fixed wing, it illustrates three different forms of graphic syllables with its Hangul name at the fuselage and cubistically unfolds the multi-dimensional phoneme spaces on both wings. The vowel table preceding the consonant table emphasizes its significance in a syllable. A linear ordering of all graphonemes in the multi-dimensional spaces can follow their formation processes. Letter names remind us their phonetic values and syllabic compositions. Initial and final graphemes are named by open and closed syllables combining them with - for [ [symbol] ] before and after, respectively. The name of a consonant having both opening and closing sounds is a disyllabic word with their grapheme names. Also, the disyllabic name can be shortened into a monosyllabic name by the phonological contraction of two same vowels in a row. IPAs can replace letter names in FIG. 1.

Vowel Graphonemes

For the primitive vowels of the present disclosure, the geometric primitives outline the vibrant articulators of their sounds, i.e., [Λ], [ [symbol] ], and [i], in FIG. 12. First, the dot (⋅) characterizes the vibrant palate in FIG. 12a when [Λ] is produced at the middle height of the jaw. Second, the horizontal line (-) characterizes the flat of the vibrant tongue in FIG. 12b when [ [symbol] ] is produced at the minimal height of the jaw. Third, the vertical line (|) characterizes vibrant open sides of the raised tongue back in FIG. 12c when [i] is produced at the minimal height of the jaw. They form the tripod of all diverging, converging, and iotized vowels in FIG. 10a. They listed over the round Hundli pattern or along the right articulatory profile recapitulate the above discussion and enhance the comprehension in graphonemic symmetry.

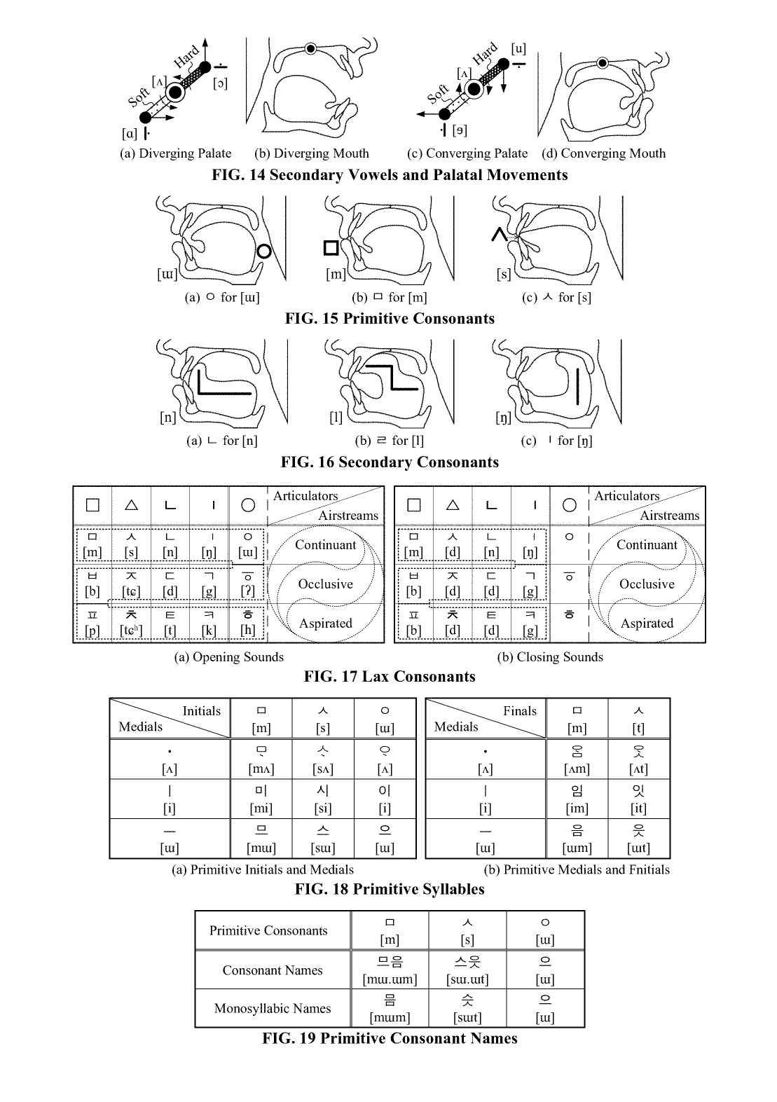

For the secondary vowels of the present disclosure, their letters also outline phonetic qualities of their sounds, i.e., rising [ [symbol] ], outgoing [α], falling [u], and incoming [ [symbol] ], and corresponding movements of their active palates with combinations of the geometric primitives in FIG. 14. Their phonetic articulations are very distinct from each other by the vowel height and shape of the lips in FIG. 10a. Notably, the soft palate vibrates lightly when we pronounce [α] and [ [symbol] ] with unrounded lips. The pursed lips to pronounce [ [symbol] ] and [u] increase the air pressure in the front side of the oral tract and vibrate the hard palate heavily in a relative sense. Suppose a palatal plane rotating about the palatal center ( [symbol] ) and horizontally aligned with the lower jaw. In the palatal plane, the soft palate moves forward while the hard palate moves upward in FIG. 14a when we open the mouth in FIG. 14b. Conversely, they move the other way in FIG. 14c when we close the mouth in FIG. 14d. [symbol] for [α] indicates the soft palate moving forward or rightward in the right articulatory profile and thus places a dot (⋅) for the active palate to the right-side of the vertical reference line (|). [symbol] for [ [symbol] ] indicates the active palate moving backward. Likewise, [symbol] for [ [symbol] ] and [symbol] for [u] indicate the hard palate moving upward and downward by a dot above and below the horizontal line (-), respectively. The secondary vowels around [Λ] form a palatal vowel cross with the relative movements of their active palates. In the upper half of FIG. 13a, the pictographic vowels are arranged by two phonetic qualities: phonetic weight (or feel) and flow.

The iotized vowel letters of the present disclosure add a dot or a vertical line to their base letters. There are two types of iotation depending on the occurrence of |: pre-iotation (pre-occurrence of the sound |) and post-iotation (post-occurrence of the letter |). The raised tongue back in FIG. 12c modulates all pictographic vowels except | into their post-iotized vowels, whose letters are denoted by adding | to the right of their base letters as in FIG. 13a. For example, [symbol] for [æ] and [symbol] for [e] are the post-iotized vowels of [symbol] and [symbol] , respectively. Sometimes, big post-iotized vowels, i.e., [symbol] , [symbol] , and [symbol] , are diphthongized to [ [symbol] i], [we], and [wi], respectively. The pre-iotized vowels of simple vowels are their palatal on-glides with [j], whose letters are denoted by adding a dot beside the existing dot of their base letters in FIG. 13b. For example, [symbol] for [jα] and [symbol] for [jæ] are the pre-iotized versions of [symbol] and [symbol] , respectively.

In the present disclosure, a composite vowel forms a big vowel as its sound forms a complex vowel in vowel harmony, i.e., a leading heavy fat vowel followed by its adjacent light tall vowel in FIG. 13c. For example, [symbol] for [wα], a composite of [symbol] and [symbol] , is pronounced by releasing pursed lips for [symbol] quickly and opening the mouth for [symbol] as their articulations are close enough to have the same phonetic flow in FIG. 10a. Thus pronunciation efficiency or articulation economy explains the vowel harmony in labial and palatal on-glides to reduce articulatory movements.

Consonant Graphonemes

For primitive initials of the present disclosure, the basic shapes outline the articulators of their sounds, i.e., [ [symbol] ], [m], and [s]. A circle, square, and triangle characterize the round throat, square lips, and sharp teeth in FIG. 11d. Despite our preoccupation with silence for ∘, soft airflow from a relaxed larynx with no tension produces [ [symbol] ] in FIG. 15a or FIG. 12b. This articulation defines the reference state of air switching where an opening articulation ends and a closing articulation starts. For example, the opening lips that articulate from the shutting lips in FIG. 15b to the reference point produce their opening sound, i.e., [m], instantly by escaping air through them. With the tongue tip, the opening teeth from FIG. 15c to a produce the opening [s].

In the present disclosure, reverse articulation of an initial phoneme, if possible, defines the final graphoneme that reuses the initial grapheme. This is the same for three primitive finals of the present disclosure. First, the closing lips that articulate from FIG. 15a to b produce their nasal sound, i.e., the closing [m], by escaping air through nasal tract. Second, the teeth can close the oral tract airtight together with the tongue tip that produces the closing [d]. Third, the throat cannot close the vocal tract so that its closing sound is not applicable.

The primitive consonants of the present disclosure can best represent all lax consonants and their phonological properties. First, ∘ represents a source sound and notational basis of all opening consonants. Second, [symbol] can represent twice differentiable consonants, more specifically nasal consonants, that have their own closing sounds up to their first derivatives. Third, [symbol] can represent twice differentiable consonants that do not have their own closing sounds.

For the secondary consonants of the present disclosure, their letters outline the tongue shapes when making their sounds, i.e., [n], [1], and [ [symbol] ]. By parts or modification of a square, [symbol] , [symbol] , and | characterize the erected tip, bent body, and raised back of the tongue, respectively, in FIG. 16. Their opening and closing articulations are the same as [symbol] . In particular, [symbol] and | are nasal sounds that have similar phonological properties with [symbol] as they are graphically close. Notably, [symbol] exaggerates the bent curve with more strokes to distinguish it from the others because its lax derivatives are not used in the Korean language. By a cosmic analogy of the tongue as a whole, its free tip, rooted back, and flexible body correspond to Hun, Dl, and I, respectively. To sum up, respective primitive and secondary consonants listed over the Hundli pattern or along the left articulatory profile recapitulate the above discussion and enhance the comprehension.

The consonant letters of homorganic derivatives add one or two strokes to their base letters depending on their burst strength. By the ternary burst strength, continuant, occlusive and aspirated consonants complete their trilateral airstreams over the Hundli pattern in FIG. 17a. For example, ⊂ for [d] and [symbol] for [t] add a horizontal stroke for a stronger burst to [symbol] for [n] and ⊂ for [d], respectively. [symbol] for [g] and [symbol] for [k] do likewise to | for [ [symbol] ] and [symbol] for [g], respectively. Remarkably, [symbol] breaks a stroke into two pieces and puts them on top of [symbol] like the horns creatively. [symbol] also breaks two strokes into twos and puts them beside [symbol] like a double wing.

Not all closing consonants of the homorganic derivatives are phonetically distinguishable but they are refreshingly principled in the present disclosure. First, closing articulations of the aspirated nasal consonants ( [symbol] , [symbol] , and [symbol] ) diminish their phonations quickly and eliminate the distinctive phonetic features from their occlusive ones ( [symbol] , ∪, and [symbol] ) in FIG. 17b. Second, like ∘ and [symbol] , their closing derivatives behave the same way. FIG. 17 overlying [symbol] of the rectangular Hundli pattern can remind us of all lax consonants in the present disclosure.

Homogeneous digraphs of the present disclosure represent all tensed consonants by putting their base letters side by side. In contrast to a lax sound, its tensed sound is a sound with a high tone made by increasing glottal tension at any time of pronunciation process. For example, [symbol] denotes the tensed sound of [symbol] , i.e., [ [symbol] ]. Among all possible tensed graphonemes of the present disclosure, only five are effective in the current Korean orthography: [symbol] , [symbol] , [symbol] , [symbol] , and [symbol] . Although complex consonant sounds are not allowed in the Korean language, inhomogeneous consonant digraphs are placed at the final position for its morphophonemic orthography.

Remarkably, | of the present disclosure solves the missing puzzles in |, ∘, and [symbol] , where [symbol] is the old letter whose only closing sound is known as [ [symbol] ]. Both sides of the raised tongue back can produce the opening |, lasting |, and closing | that have graphic similarities. The opening sound of | is close to that of ∘ in its articulatory neighbour. The closing sounds of | and [symbol] are assumed to be the same, and so are their opening sounds. Originally, [symbol] might attach ∘ below | to graphically distinguish | from | and to consider the phonetic similarity of | and ∘ in the pictographic principle. As the opening \dot{∘}became ∘ or obsolete in the Korean orthography, ∘ void of the closing sound replaced [symbol] by their phonetic and graphic similarities.

### Examples of Hangul Syllables

Whenever new graphonemes acquired, open and closed syllables combining them with the primitive vowels or consonants can be exemplified to enhance the learning effect of syllabic composition. For example, all combinations of three primitive vowels and consonants populate the primitive syllables of the present disclosure in FIG. 18. The primitive consonant names are illustrated in FIG. 19. The IPA is not utterly compatible with Hangul in that it can denote some letters, e.g., [symbol] , differently. Other syllables can be presented to practise their four language skills.

### REFERENCE NUMERALS

| | | |
|---|---|---|
| 100: Hangul module | 200: Hundlism module | |
| 300: Syllable module | 310: Speech syllable module | 320: Graphic syllable module |
| 400: Graphoneme module | 500: Phoneme module | 600: Grapheme module |
| 800: Interaction module | 810: Language processing module | 820: Speech processing module |
| 830: Display module | 840: Database module | 850: Image processing module |
| 900: Evaluation module | 910: Language evaluation module | 920: Sound evaluation module |
| 930: Analysis module | 940: Advice module | 950: Letter evaluation module |

What is claimed is:

1. A Hangul acquisition system comprising:
a processor and a memory;
a Hundlism session presenting a scientific paradigm which summarizes articulatory phonetics and design principles of Hangul; and
a syllable session presenting at least one syllable with articulatory phonetics and design principles thereof based on the scientific paradigm.

2. The Hangul acquisition system of claim 1, further comprising:
a primitive graphoneme session presenting at least one primitive graphoneme, wherein each of the at least one primitive graphoneme comprises a primitive grapheme and a primitive phoneme, and the primitive grapheme outlines an articulator of the primitive phoneme.

3. The Hangul acquisition system of claim 1, further comprising:
a secondary graphoneme session presenting at least one secondary graphoneme, wherein each of the at least one secondary graphoneme comprises a secondary grapheme and a secondary phoneme, and the secondary grapheme outlines an articulation manner of the secondary phoneme.

4. The Hangul acquisition system of claim 1, further comprising:
a tertiary graphoneme session presenting at least one tertiary graphoneme, wherein each of the at least one tertiary graphoneme comprises a tertiary grapheme and a tertiary phoneme, and the tertiary grapheme denotes an articulatory feature of the tertiary phoneme.

5. The Hangul acquisition system of claim 1, wherein at least one phoneme and at least one grapheme for the at least one syllable are organized by trilateral, quadrilateral, or mixed formation processes thereof.

6. The Hangul acquisition system of claim 1, wherein the scientific paradigm conceives a trilateral process and reality in nature such that
Hun of the scientific paradigm represents a diverging process or derived thing;
Dl of the scientific paradigm represents a converging process or basic thing; and
I of the scientific paradigm represents a binding process or composed thing.

7. The Hangul acquisition system of claim 1,
wherein each of the at least one syllable has a trilateral phonetic structure in time such that
an initial phoneme, if any, is an opening sound of a syllabic segment;
a medial phoneme is a lasting sound of the syllabic segment; and
a final phoneme, if any, is a closing sound of the syllabic segment.

8. The Hangul acquisition system of claim 1,
wherein each of the at least one syllable has a trilateral graphic structure on paper such that
an initial grapheme, if any, is placed at the top of a syllable block;
a medial grapheme is placed in the middle of the syllable block; and
a final grapheme, if any, is placed at the bottom of the syllable block.

9. The Hangul acquisition system of claim 1, further comprising:
an interaction module exchanging audiovisual data with a learner.

10. The Hangul acquisition system of claim 9, further comprising:
an evaluation module testing and evaluating at least one of four language skills for syllables or graphonemes.

11. A non-transitory computer-readable medium storing computer-readable instructions causing a computer having a processor and a memory to execute Hangul acquisition method, the Hangul acquisition method comprising:
presenting a scientific paradigm which summarizes articulatory phonetics and design principles of Hangul;
presenting at least one syllable with articulatory phonetics and design principles thereof based on the scientific paradigm; and
presenting at least one graphoneme with articulatory phonetics and design principles thereof based on the scientific paradigm.

12. The non-transitory computer-readable medium of claim 11, the step of presenting at least one graphoneme comprising:
a primitive graphoneme session presenting at least one primitive graphoneme, wherein each of the at least one primitive graphoneme comprises a primitive grapheme and a primitive phoneme, and the primitive grapheme outlines an articulator of the primitive phoneme.

13. The non-transitory computer-readable medium of claim 11, the step of presenting at least one graphoneme further comprising:
a secondary graphoneme session presenting at least one secondary graphoneme, wherein each of the at least one secondary graphoneme comprises a secondary grapheme and a secondary phoneme, and the secondary grapheme outlines an articulation manner of the secondary phoneme.

14. The non-transitory computer-readable medium of claim 11, the step of presenting at least one graphoneme further comprising:
a tertiary graphoneme session presenting at least one tertiary graphoneme, wherein each of the at least one tertiary graphoneme comprises a tertiary grapheme and a tertiary phoneme, and the tertiary grapheme denotes an articulatory feature of the tertiary phoneme.

15. The non-transitory computer-readable medium of claim 11,
wherein at least one phoneme and at least one grapheme for the at least one syllable are organized by trilateral, quadrilateral, or mixed formation processes thereof.

16. The non-transitory computer-readable medium of claim 11,
wherein each of the at least one syllable has a trilateral graphic structure on paper such that
an initial grapheme, if any, is placed at the top of a syllable block;
a medial grapheme is placed in the middle of the syllable block; and
a final grapheme, if any, is placed at the bottom of the syllable block.

17. The non-transitory computer-readable medium of claim 11, further comprising:
an interaction module exchanging audiovisual data with a learner.

18. The non-transitory computer-readable medium of claim 11, further comprising:
an evaluation module testing and evaluating at least one of four language skills for syllables or graphonemes.

19. The non-transitory computer-readable medium of claim 11, wherein the scientific paradigm conceives a trilateral process and reality in nature such that
Hun of the scientific paradigm represents a diverging process or derived thing;
Dl of the scientific paradigm represents a converging process or basic thing; and
I of the scientific paradigm represents a binding process or composed thing.

20. A Hangul learning material comprising:
a Hundlism section presenting a scientific paradigm which summarizes articulatory phonetics and design principles of Hangul;
a syllable section presenting at least one syllables with articulatory phonetics and design principles thereof based on the scientific paradigm; and
a graphoneme section presenting at least one graphoneme with articulatory phonetics and design principles thereof based on the scientific paradigm.
